(19) United States
(12) Patent Application Publication
(10) Pub. No.: US 2012/0117500 A1
(43) Pub. Date: May 10, 2012

(54) METHOD FOR THE EXTRACTION, COMBINATION, SYNTHESIS AND VISUALISATION OF MULTI-DIMENSIONAL DATA FROM DIFFERENT SOURCES

(76) Inventor: Enrico Maim, Hauts De Seine (FR)

(21) Appl. No.: 12/528,258

(22) PCT Filed: Feb. 25, 2008
(86) PCT No.: PCT/EP2008/052274

§ 371 Date: Aug. 23, 2011

(30) Foreign Application Priority Data
Feb. 23, 2007 (FR) 0753440

(51) Int. Cl. G06F 7/00; G06F 3/048

(52) U.S. Cl. 715/769; 707/796; 715/781; 707/E17.056

(57) ABSTRACT

The invention relates to a method for the automatic combination of multi-dimensional data depending on manipulations at the level of their dimensions in a computer environment that comprises computer equipment capable of accessing multi-dimensional data sources. The method comprises the following steps: a) providing a first multi-dimensional data source; b) providing at least a second multi-dimensional data source, at least said second multi-dimensional data source being such that each data includes key values and non-key values in the different dimensions; c) identifying actions carried out using a user interface on representations of some dimensions of the sources; d) depending on said actions, combining the data sources by using the key values of each data of the second source(s) in order to establish associations between the multi-dimensional data of the first source and the multi-dimensional data of the second source(s) and to obtain combined multi-dimensional data, the combination being carried out as follows: i) adding to the multi-dimensional data of the first source at least a portion of the non-key values of the corresponding data of the second source(s); and ii) arranging the added non-key values with the pre-existing values for the same combined multi-dimensional data. The invention also relates to associated methods for the combination and enrichment of data and for the manipulation of the visualisation of resources.

The present invention relates to methods for combining and visualizing data obtained from data sources and in particular to new types of data extraction services, to methods for combining and visualizing data able to combine additional or competitive information available on the Web or in the company, and to navigate easily in the combinations done even when they represent large volume of data.

In the current state of the art, “Mashup” tools make it possible to combine data extracted from Web sites or multidimensional data sources. For example, data extracted from a Web site giving hotel addresses can be combined with data extracted from a site giving flight schedules, and further combined with data extracted from a weather forecast site.

A difficulty with these tools is that they result in larger and larger volume of data to be considered by the user. For example, if in each destination of a flight there are 10 hotels corresponding on average, the combination of the flights interesting the user with hotels will increase the quantity of information of a factor 10.

There thus exists a need for tools to combine the data by limiting the quantity of information to be taken into account, and to explore the information more easily, and also to enrich it with relevant data, all in a user-friendly way, in particular using just point and click operations.

Moreover, “mashup” tools can be used to combine information sources which are competitive by nature. For example, if one considers extractors providing, from a Web site selling books, a set of multidimensional data (typically presented in rows) made up of dimensions (typically columns) such as “Principal author”, “Title” and “Price”, a join can be carried out on the columns “Principal author” and “Title”, to compare the prices of books provided by various sellers on various sites . . . .

However a join on the column “Price” can also be carried out to compare different books having the same price, and the joins have to be specially programmed to correctly combine such data sources in spite of their recourse to different vocabularies.

So, in this profusion of means offered to the user, there do not exist generic means for, in particular,
allowing a user to interactively make correspond (or to remove such a correspondence) any dimensions of multidimensional data sources, even if they are named differently in the various sources, in order to be able to combine these sources in an automated way;
to benefit from indicators (keys), possibly already associated with the data (in the above-mentioned example only the columns “Principal author” and “Title” should typically be used as keys in order to be used as columns of join, although the user made also correspond the column “Price”), to automatically combine the data in the most suitable way, and this being determined in an automated way;
based on counting the dimension correspondences (mappings) established or removed by users, to automatically suggest to the user data sources to be combined and mappings between them;
combining the data, by taking into account their chronology and, in particular, in the order of their first appearance (as opposed to the order of their reception), and navigating in time to explore combinations of interdependent data which are not necessarily all valid at the same time.

Thus and more specifically, the objects of the invention are:
to allow the user to simply let multidimensional sources to be combined automatically, according to (key) indicators associated to the data, after having simply accepted automatic suggestions for dimensions mapping and/or by its own initiative having added new dimensions mappings;
to keep up to date automatically the results of the combinations;
to store the times of first appearance of each information so that the information of various sources is combined only during their respective periods of validity and so that the user can navigate in time to reconstitute, by combination of different sources, “debates” such as contradictory information for news, or to explore competitive offers for a product.

Thus in the previous example of combining data extracted from sites selling books, the user could map the columns “Price” of the respective sources to see in the same column the most recent price of each book; then by navigating in time, i.e. by moving in the past, she would see the price of each competitor site. Indeed, each offer was inevitably most recent once (at least at the exact moment of its first appearance), and insofar as it were not withdrawn since that moment (it is still valid), it will be presented. Last, the user could see the offers of various sites at the same time or even put his own books on sale.

Moreover, a difficulty in using the existing tools for visualizing tabular data lies in the fact that the provision of the tree structure (branching by following the columns from left to right) is established in advance whereas it may be needed to be presented in a different order.

This is unadvantageous in that it can harm the clearness of reading the data thus collapsed or expanded, typically when the user is accustomed to the given position of the columns in the initial document.

Thus there exists a need to access tabular data in which collapsing/expanding subsets can be carried out directly within the original presentation of the tabular data, by preserving its presentation and the ordering of its columns, so as to improve the readability of the tabular data and the manipulations carried out on the tabular data.

To reach at least one of the objectives above one proposes according to a first aspect of the invention an automatic method of combining multidimensional data by manipulating their dimensions in a data-processing environment, comprising a data-processing equipment able to access multidimensional data sources, characterized in that it comprises the following steps:
(a) providing a first multidimensional data source;
(b) providing at least one second multidimensional data source, at least in this second source each data having key values and non-key values in its dimensions;
(c) identifying actions carried out using a user interface on representations of certain dimensions of the sources;
(d) depending on the said actions, combining the data sources by using the key values of each data of the second source(s) to carry out associations between the multidimensional data of the first source and the multidimensional data of the second source(s) and thus obtaining combined multidimensional data, the said combination being carried out (i) by adding to the multidimensional data of the first source at least part of the non-key values of the corresponding second data source(s), and (ii) by arranging the added non-key values with preexistent values for the same combined multidimensional data.

The invention proposes according to a second aspect an automatic method of combining multidimensional data from a plurality of data sources, characterized in that it includes a succession of executions in cascade of the abovementioned method, the combined data resulting from one execution of the said method constituting a data source for the next execution of the said method.

Certain preferred but non restrictive aspects of this method are the following:
the arrangement of the added non-key values with preexistent values for the same combined multidimensional data includes the selection of one non-null value among the values coming from the different sources.
the arrangement of the added non-key values with respect to preexistent values for the same combined multidimensional data comprises the selection of a value among the values coming from the different sources according to a given decision-making method.
to each data a period of validity is associated, and the decision-making method comprises the selection of a value belonging to a data which is valid on a given date.
to each data a date of first appearance is associated, and in which the decision-making method comprises the selection of the value from the data that appeared the most recently before a given date.
the method includes, for the data of a source to which no date of first appearance has been associated, a step of creation of a date of first appearance equal to the date at which the data was involved in a combination of data for the first time.
at least one of the multidimensional data sources comprises at least two upstream data sources and the information defining a combination previously carried out.
the said actions are manipulations on a graphical interface of a representation of at least one dimension of the second source in order to map it with a representation of at least one dimension of the first source or to insert it between two dimensions of the first source, these dimensions determining either the said associations between data, or the said arrangements of non-key values of the second source with values of the first source, according to whether the dimension of the second source corresponding to the manipulated representation contains or not key values.

According to a third aspect it is proposed a method of combination of multidimensional data, comprising the following steps:
providing an access to a plurality of data sources,
memorizing, from combinations carried out by the method of claim 1, mapping of information between data sources
at the time of access a data source which has already been combined with other data source(s), signaling the existence of some or all the said other data source(s).

Certain preferred but non-restrictive aspects of this method are the following:
mapping information also comprises the information of dimensions mapping between the said sources and comprising moreover, at the time of an access to a data source having already been combined with other data sources, signaling also the mapping between dimensions.
the method comprises moreover the execution by default of the method according to claim 1 of combining the accessed data source with the said other data sources.
information of mapping is memorized for a plurality of users, and the step of signaling is carried out according to rules of preponderance among mapping information.

A fourth aspect of the invention concerns a Method of combining multidimensional data, including the following steps:
providing access to a plurality of data sources,
memorizing mapping information between data sources based on the method of combining according to claim 1,
at the time of access to a data source having already been combined with other data sources, determining the existence of a chain of mappings between data sources, and, according to the characteristics of mapping information, to selectively combine according to the method of claim 1 the data source which is accessed and a data source related to it by a chain of at least two mappings.

A fifth aspect of the invention concerns a method of enrichment of multidimensional data by automatic combination based on manipulations on their dimensions in a data-processing environment comprising a data-processing equipment able to access multidimensional data sources, characterized in that it comprises, after having applied to a previous data source a function of selection to obtain a previous selection of data, the following steps:
at the time of access to a current data source in order to obtain a current selection of data, to determine the existence of at least one mapping of dimensions between the two data sources,
if such an existence has been determined, to apply the method of claim 1 to a first pair of first and second data sources made up respectively of the current selection and previous source, and to a second pair of first and second data sources respectively made up of the current source, from whom the current selection is withdrawn, and of the previous selection.

Certain preferred but non-restrictive aspects of this method are the following:
the mapping of dimensions between the data of the two sources is carried out during the execution of the method.
the access to the sources is carried out using a Web browser and the execution of the method is carried out by intercepting the requests towards servers and by extracting data from these servers.
the said mapping is carried out by displaying the selections of data to the user and by capturing the events that the user drags-and-drops values in the dimensions that have to be mapped.
the method further comprises a step of synthesis to display the said selections in their graphic environment and to associate to the values means to enable drag-and-drop.
the Method is executed repeatedly on accessing a succession of data sources, in which, at the time of accessing a current data source for which there does not exist any dimension mapping with the previous source, the existence of dimensions mapping between the current source and a former source is searched, and the method of enrichment is applied on pairs of sources constituted by the said former source and any source accessed more recently with which there exists a mapping of dimensions, then on a pair of sources constituted by the said former source thus enriched and the current source.
the method is executed at the time of the access to a succession of data sources SN-2, SN-1 and SN, including the following steps:
if a mapping between dimensions of sources SN-2 and SN-1 on the one hand, and SN-1, SN on the other hand exists, to execute the method between sources SN and SN-1 by using as source SN-1 the result of the method according to claim 15 executed on sources SN-1 and SN-2,
if no mapping between sources SN-2 and SN-1 exists, to determine if there exists a mapping between dimensions of sources SN-2 and SN and, in the affirmative, to execute the method according to claim 15 on the one hand on sources SN and SN-1 and on the other hand on sources SN and SN-2, and
if no mapping between the sources SN-1 and SN exists, to determine if there exists a mapping between dimensions of sources SN-2 and SN and between sources SN-2 and SN-1 and, in the affirmative, to execute the method according to claim 15 on the one hand on sources SN-1 and SN-2 and on the other hand on sources SN and SN-2.
   and so on for sources SN-3, SN-4, etc.

According to a sixth aspect of the invention, it is proposed a method to manipulate the visualization of a resource containing information structured in the form of a table (array) with at least two dimensions, where a dimension of the table is constituted by columns representing data types, and another dimension of the table is constituted by rows, each row representing a line of associated data having the respective types, characterized in that the method comprises:

(a) displaying in the form of a single row a group of lines of associated data having all same value in a given column,
(b) displaying, in the given column, the said value, and
(c) displaying, in association with at least one other column, an indicator signaling that there exist at least two values in this other column for the said group of lines.

Certain preferred but non-restrictive aspects of this method are the following:
the method comprises a step consisting, on an action performed by the user using an input user interface with relation to the said other column at the level of the said single row, of causing the display of the different values taken by the group of lines in this other column.
the said display is carried out value by value.
the said display is carried out in a pop-up menu or window.
the method further comprises the following step:
   (d) in answer to an action performed by the user using an input user interface in relation to the said indicator, the expansion as a sub-table of the said single row.
each row of the said sub-table contains a different value in the said other column and represents a sub-group of lines all having this value in the said other column.
the method comprises the repetition of the steps (b) to (d) for at least one of the rows constituting the said sub-table, repetition applied to at least one more other column in which there exist at least two values for the sub-group of lines corresponding to the said row at least.
there exists a virtual additional type “row”, the table being initially presented in the form of a single row gathering all the rows, an indicator being displayed in association with each column in which there exist at least two values.
each row of the said sub-table represents, for the columns with the indicators from which the sub-table was formed, a specific combination of different values.
the method comprises displaying an indicator associated with the said other column after expansion and on which an action performed by the user using an input user interface causes collapsing the said sub-table in order to result in the said single row.
the indicator associated with the said other column comprises a symbol that can be directed downwards or upwards.
the method comprises displaying in the said other column, one of the values taken by the group of lines in this column.
the method comprises displaying in the said other column, a combination of the values taken by the group of lines in this column.
the method comprises displaying in the said other column, a property such as the cardinality of the set of the values taken by the group of lines in this column or the result of an aggregation function applied on these values.
the method comprises a step of determining a lines selection key for determining a group of lines to which a change of value in a column at the level of a displayed row will apply collectively.
the said lines selection key is constituted by the values displayed in the column(s) having the indicator(s) from which the sub-table was formed.
the said lines selection key is constituted by the values displayed in all the columns, including the value before change for the column in which the change is carried out.
the said lines selection key is constituted by the value before change in the column in question.
the method comprises a step of addition to the lines selection key of a value displayed in a column from which no sub-table was formed, by a specific action using an input user interface.
the method comprises a step of removal from the lines selection key of a value displayed in a column from which no sub-table was formed, by a specific action using an input user interface.
if the resource is built dynamically from a data source, it is able to display in association with the resource an indicator enabling a direct access to the said data source.

Finally the invention proposes a method of presentation of data, comprising the following steps:

(a) defining a presentation template for a source from which data can be obtained in order to be manipulated according to the method defined with respect to the sixth aspect of the invention,

(b) synthesizing at least a part of the said data in the said presentation template according to predetermined rules, and

(c) when with one of the said data an indicator has to be associated according to the said method, to display an equivalent indicator in the said synthesized presentation.

The figures respectively illustrate these various approaches of use. It is supposed that the user combines the data sources¹ “Seller2” and “Seller3” with the data source “Seller1”. ¹ In the following the terms “multidimensional data sources” and “data sources” are used in an interchangeable way, and the term “data source” is sometimes used instead of “table from data source”.

[symbol]

Seller1

[symbol]

| Principal | | | | | Valid |
|---|---|---|---|---|---|
| author | Title | Seller | Price | Valid since | until |
| Author1 | Title1 | Seller1 | 25 | Mar. 21, 2007 | null |
| | | | | 08:15 | |
| Author2 | Title2 | Seller1 | 24 | Mar. 22, 2007 | null |
| | | | | 10:05 | |
| Author2 | Title3 | Seller1 | 20 | Mar. 15, 2007 | null |
| | | | | 11:10 | |
| Author3 | Title4 | Seller1 | 15 | Feb. 27, 2007 | Mar. 22, 2007 |
| | | | | 11:50 | 11:49 |

“Seller2” and “Seller3” having the same columns as “Seller1” but with respectively the additional columns “Number of pages” and “Rating”.² ² Thus on the basis of the key made up of the columns “Principal author” and “Title”, the sources “Seller2” and “Seller3” contribute the values on the one hand together to the column “Price” and on the other hand respectively to the columns “Number of pages” and “Rating”. It is considered here that the sources presented are in fact “selections” and that the method of enrichment (described later) of selections are applied.

[symbol]

Seller2

[symbol]

| Principal | | | | Number of | | Valid |
|---|---|---|---|---|---|---|
| author | Title | Seller | Price | pages | Valid since | until |
| Author1 | Title1 | Seller2 | | 350 | Mar. 1, 2007 | March 22nd |
| | | | | | 12:00 | 12:00 |
| Author2 | Title2 | Seller2 | 25 | 430 | Mar. 23, 2007 | null |
| | | | | | 14:15 | |
| Author3 | Title4 | Seller2 | 12 | 62 | Mar. 23, 2007 | |
| | | | | | 09:00 | |

[symbol]

Seller3

[symbol]

| Principal | | | | | | Valid |
|---|---|---|---|---|---|---|
| author | Title | Seller | Price | Rating | Valid since | until |
| Author1 | Title1 | Seller3 | 25 | *** | Mar. 22, 2007 | null |
| | | | | | 10:00 | |
| Author2 | Title2 | Seller3 | 26 | ** | Mar. 23, 2007 | null |
| | | | | | 14:14 | |

It should be noted that the values of the temporal columns “Valid since” and “Valid until” come from automatic detection of the first (resp. last) appearance of the data in the respective data sources, that the “null” values indicate an unknown value, and that the vertically repeated values are not presented. In the following figure “Author2” is repeated in two rows but is mentioned in only one, since each missing value represents a repetition of the value above. This case happens when, starting from an already expanded value of a column of a row, a value of another column of the same row is expanded. This is the 6^{th} aspect of the invention as mentioned before and is described later in the text.

In the first approach (FIG. 1) the user positions at “Now” on the time axis and sees the most recent offers for the values which are expanded (which in the figure is prefixed with the symbol “̂”)³ and which is still valid. The user sees there in particular the book {Author1, Title1} proposed by Seller3 with a “Rating” of “***” (in the first row displayed in the figure) and the book {Author2, Title2} proposed by Seller2 (in the second row displayed in the figure)⁴. The user notices that, although the source Seller2 does not provide a “Rating”, there is a value “**” in this column in the second line. By moving the cursor of the mouse over the value in question, she sees that it was obtained by combination with a former offer (and which is always valid) of Seller3. To be noted finally that since the Seller2 source is contributing the column “Number of pages”, all the rows coming from Seller2 present values in this column. ³ The concept of “expanded” or “collapsed” cell is used in the 6^{th} aspect of the invention which is described later. For sake of clarity, in the figures here the symbol “\check{}” is not displayed and so it is not indicated that a cell is collapsed.⁴ As presented in the figure it is now 15:20 and she can optionally see that this offer is “Valid since” 14:15.

In FIG. 2, the user positioned in the past (precisely at time Mar. 22, 2007 10:10) by drag-and-dropping the temporal cursor⁵ towards the left. Below is what she sees. ⁵ (which, in the previous figure, was positioned on “Now”)

First row of FIG. 2:

Although the Seller3 source does not provide a column “Number of pages”, now the user sees the value “350” in there. When she brings the cursor of the mouse to it, it is displayed that this value is obtained by combination with the source Seller2⁶. ⁶ The corresponding row, which is less recent (“Valid since”: “Mar. 1, 2007 12:00”), is still valid at the positioned time: “|Mar. 22, 2007 10:10”. It should be noted that the column “Valid until” not being opened (columns can be hide or shown), as this value “350” belongs to a data which is not valid anymore now (its date of end of validity is March 22nd, 12:00) another implementation could take the option of not presenting it.

Second row of FIG. 2:

The user now sees for {Author2, Title2} the row of Seller1 with a “Price” of “24”, which was the most recent offer at the time Mar. 22, 2007 10:10 for the expanded values and which is still valid now.

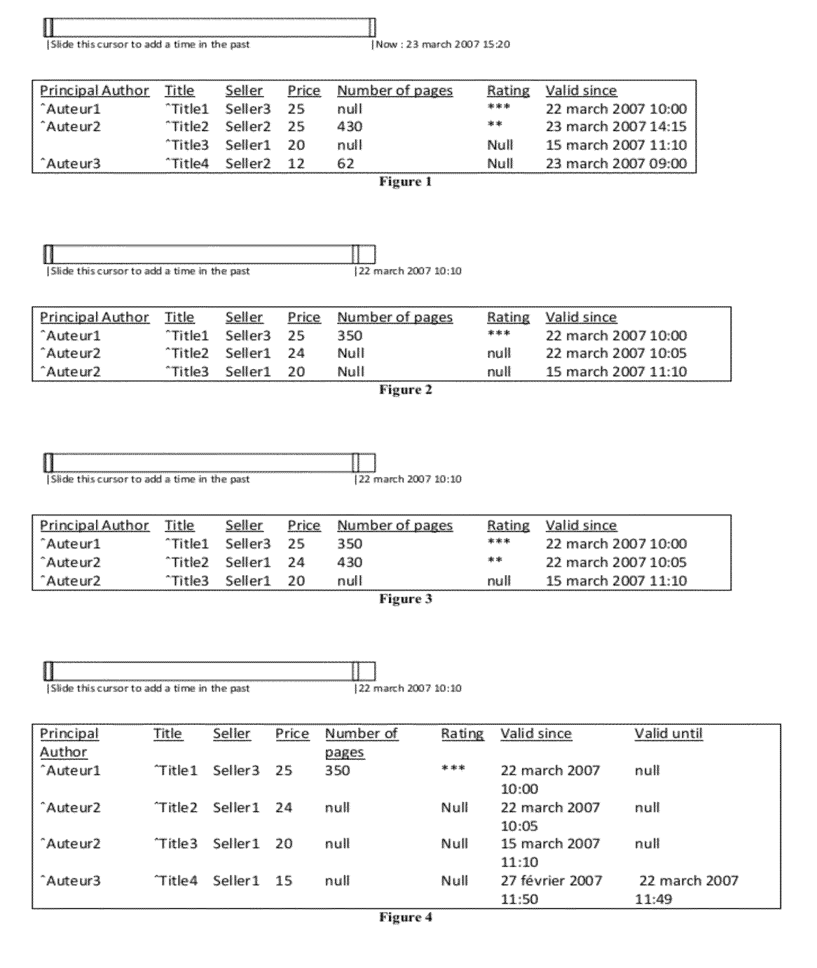

The user there who is interested in this offer whose price is more advantageous (“24” instead of “25”), might want to see (as in FIG. 3) the “Number of page” (“430”) and the “Rating” (“**”) displayed, which is not mentioned and which she had noticed for {Author2, Title2} when she was positioned at time “Now”. With this intention she will activate an option which makes it possible to supplement the missing data (this option functions only if the value of the cell is “null”) with the data which were inserted after positioned time and are valid at the time “Now”.

Third line of FIG. 2:

The offer of Seller1 for {Author2, Title3} is still there⁷. On the other hand, the fourth row of FIG. 1, which presented an offer for {Author3, Title4}, is not presented since it had appeared after Mar. 22, 2007 10:10 and in the data sources there is no for this book other offers that appeared before this date and are still valid at time “Now”. ⁷ Being always valid since Mar. 15, 2007 11:10 it was thus valid in the positioned time (“|Mar. 22, 2007 10:10”).

In FIG. 4, the opening of the optional column “Valid until” made it possible to present in addition the rows (in fact there is only one of them) which are not valid any more now, although being most recent⁸ at the time indicated by the position of the temporal cursor (at Mar. 22, 2007 10:10). Thus, to replace the fourth row of the first figure which had disappeared from the presentation in the two preceding figures, for {Author3, Title4} is now presented a row which was valid in the time Mar. 22, 2007 10:10 but which is not valid since Mar. 22, 2007 anymore at 11:49 (which thus explains why it is not shown when this column is not displayed). ⁸ (for the expanded values)

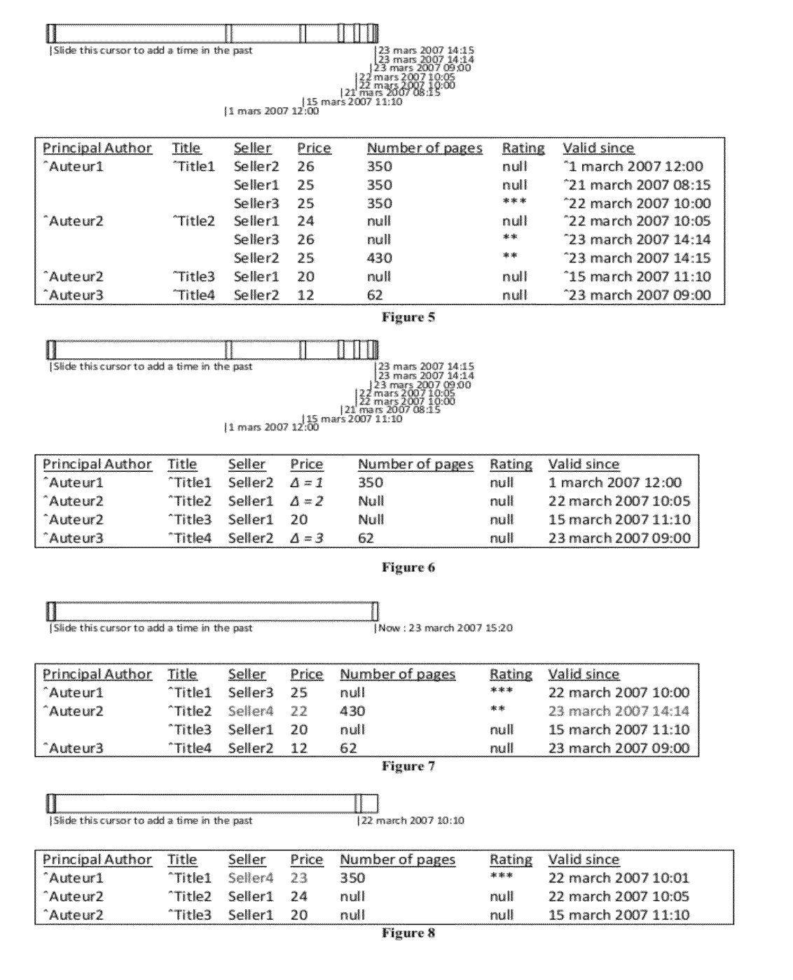

The offer of Seller1 for the book {Author2, Title2} is more advantageous (since it costs less) than that of Seller2 and, although less recent, it is still valid now. But are there offers even more advantageous (and still valid)? The user can make displayed all the now valid offers of the involved sources, as FIG. 5 presents it, by expanding all the values of the column “Valid since”.⁹ ⁹ The figure also shows a set of temporal cursors, one per start date of validity (date of first appearance) present in the table. To place (manually) several temporal cursors would mean (for the user) to make displayed the union of the rows of the table corresponding to the placed cursors. The fact of expanding all column the “Valid since” (this could be done by clicking on a symbol \check{} not shown in the figure) indeed amounts to make displayed the union of the rows representing the respectively most recent offers with regard to these temporal cursors.

The user may also want to see the price differences in time for each book, as presented in FIG. 6, or any other aggregation function (such as Min, Max, Average, etc) applied to a collapsed cell, as it will be described later.

Let us suppose now that the user combines these sources with in addition the data source “Seller4” (see below) including the columns “Min Number of pages”, “Max Number of pages”, “Rating”, “Seller” and “Price”, the first three being the key, with a condition on the key expressing that the number of pages must be between the values given in the first two columns.

[symbol]

Seller4

[symbol]

| Min Number of | Max Number of | | | | | Valid |
|---|---|---|---|---|---|---|
| pages | pages | Rating | Seller | Price | Valid since | until |
| 300 | 400 | *** | Seller4 | 23 | Mar. 22, 2007 | null |
| | | | | | 10:01 | |
| 400 | 500 | ** | Seller4 | 22 | Mar. 23, 2007 | null |
| | | | | | 14:14 | |

The result is the one obtained in FIG. 7 where (the book) Author2 Title2 is given by Seller4 to the price of 22 and if the user repositions to “Mar. 22, 2007 10:10” she obtains the result of FIG. 8 where Author1 Title1 is offered by Seller4 to the Price of 23.

Up to now one made the assumption that the respective columns of the tables of the various data sources (Seller1, Seller2, Seller3 and Seller4) were already put in correspondence (mapped), i.e. for example “Principal author” of table “Seller1” corresponds to “Principal author” of table “Seller2” (these columns having been able to be labelled differently in the different sources!).

The method of mapping—and then the method of suggestion or automatic application of mapping—multidimensional data sources and their respective dimensions (columns) is now described.

Essentially the aim of the method is to unify the respective vocabularies of the combined sources.

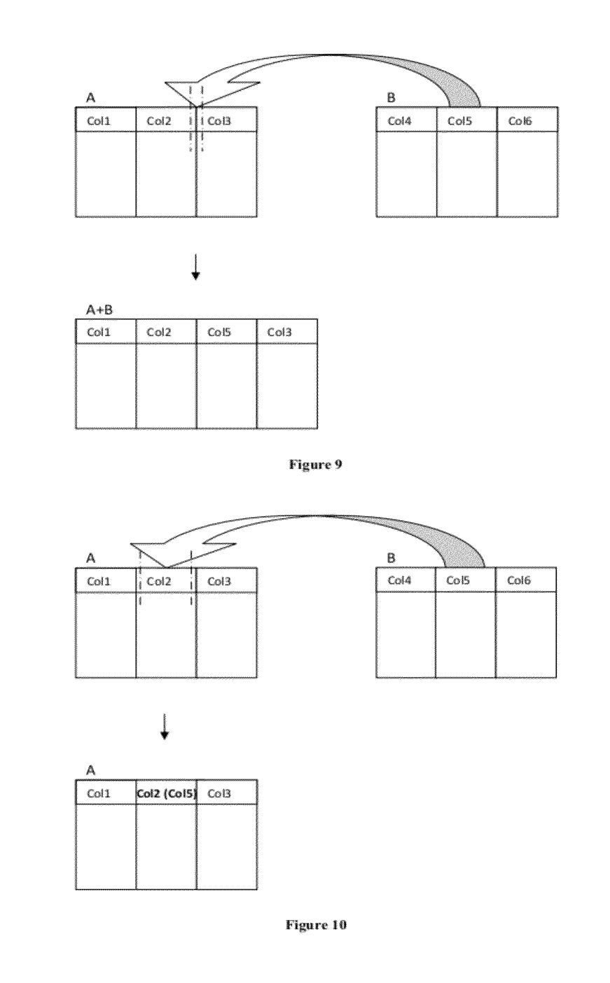

The principle of a user interface of mapping of columns is schematized in FIGS. 9 and 10. FIG. 9 shows that the table B being combined with the table A, and that the Col5 column of B being drag-and-dropped between the columns Col2 and Col3 of A, the corresponding values of Col5 of B are displayed in the result A+B within a new Col5 column placed between Col2 and Col3¹⁰. FIG. 10 shows that table B being combined with the table A, and the Col5 column of B being drag-and-dropped on the Col2 column of A, these two last are mapped (put in correspondence) and thus, in result of combination the appropriated values of Col5 of B are displayed in the resulting table A+B within the same Col2 column (called “Col2 (Col5)” in the figure). By means of dashed lines the areas are highlighted making it possible to distinguish (during the detection of “on drop” events) these two cases of drag-and-drop. ¹⁰ Of course it is assumed here that first a key column was mapped to allow the join between A and B.

By mapping the Col5 column of B and the Col2 column of A, the user indicates to the system that these columns contain values that can be combined.¹¹ ¹¹ In the previous examples it was understood that the column “Principal author” of table “Seller1” and the column “Principal author” of table “Seller1”, and so on, had been explicitly mapped by the user (unless of course there was a mechanism of automatic recognition of similarity of the columns in question).

Mappings of data sources tables, and of columns between tables, carried out by users are counted and this makes it possible to determine which mappings to suggest (or to automatically apply by default) to the users automatically¹². ¹² With respect to counting and suggesting combinations, the design of the implementation is trivial. Regarding the suggestion of mappings of columns, the implementation can consist of, for each pair among the columns being in the current combination of tables, to consider the set of the users having combined the tables in question (where the columns are forming the pair in question) and which kept this combination in the form of a memorized version (i.e in the form of a “view”), and to count the number of times that this pair is mapped in the said memorized version (in order to take per user the average for all the memorized versions where this combination is kept) and the number of times that a suggestion of the said mapping has been rejected by a user. If the number resulting from counting is large, and that the number corresponding of the rejection of suggestion is negligible, to suggest the said mapping at the time of a new combination (or to carry out the mappings of column automatically, by default, during the combinations), the thresholds “large” or “negligible” depending on the popularity of the tables in question. To be noted however that managing views involves avoiding cycles (a first view referring to a second view which makes directly or indirectly reference to the first); it is enough for that the system avoids recording with the same name a view which is referred in another view and which introduces a cycle because of a reference that it contains. Here by suggesting we mean to suggest or apply by default.

Weights are associated with the mappings during their counting so that the rules of preponderance privilege the mappings made by “close” users, for example the users working in the same field. And, of course, the mappings made by the current user herself are proposed to her first.¹³ ¹³ Moreover access rights can be associated to the combinations and mappings, so that for example the combinations made by a user can be for her only.

Thus new data sources can be combined automatically by default, provided that they were already combined previously. For example, a user creates a data source “Seller5” (for example starting from an already existing source, e.g. starting from “Seller1”) and presents the offer of a book “Author1” “Title1” (for example a used book she would like to resell). Another user who access “Seller1” would get the offer of “Seller5” since a relatively large number of other users already combined “Seller5” with “Seller1” and mapped their columns.

As already described, if the offer of “Seller5” is most recent, the said other user would see the offer of “Seller5” instead of the offers of other sellers; if not, she will be able to see it while moving in the past (by moving the temporal cursor towards the left). In this approach of combinations by default, a graphical means is offered to the user to make disappear from the display the values coming from a certain source combined by default, i.e. to reject the combination in question, or to undo a certain mapping of columns applied for her by default, then these rejections are taken into account in the countings mentioned above to influence the suggestion—or applications by default—that will be done.

In a finer way, even the presented data can be taken into account in the countings. Let us take the example above with “Seller5” and specify it further in a new scenario:

The Seller5's offer will not be presented in all the cases to the user who accesses “Seller1”, but only if “Author1” “Title1” is presented to her (in the table “Seller1”, as a consequence of her manipulations, e.g. her filtering on that particular book), because it is only when “Author1” “Title1” has been presented to them that a relatively large number of other users had combined “Seller5” with “Seller1” (and not when they visualized data on any other book). Thus, the said countings can moreover take into account the data¹⁴ visualized by the user during the combinations. ¹⁴ More precisely collapsed (or explicitly selected) values of these data, this concept being described later.

Here a more complete example. The idea is as follows:

A data extractor provides data from the Web site of Yamazuki, the manufacturer of motor bikes, who presents all the motor bikes of this brand, with all their characteristics.

[symbol]

Yamazuki

[symbol]

| Type of motor | | | Valid |
|---|---|---|---|
| bike | Characteristics . . . | Valid since | until |
| RS750 | . . . | Mar. 20, 2007 | null |
| | | 10:00 | |
| . . . | | | |

A private person publishes a data source “I sell” containing a row presenting the type of motor bike (as key), the details, the price and the place of sale of a recent Yamazuki motor bike that she puts on sale.

[symbol]

I sell

[symbol]

| Type of motor | De- | | | | Valid |
|---|---|---|---|---|---|
| bike | tails . . . | Price | Place | Valid since | until |
| RS750 | . . . | 5000 | Fontainebleau | Mar. 23, 2007 | null |
| | | | | 17:00 | |

Then, herself and other user(s) combine this source “I sell” with the source “Yamazuki”, by mapping the columns (of course they can be named differently) which identify the exact type of the motor bike that is put on sale.

[symbol]

Yamazuki + I sell

[symbol]

| Type of motor | | | | | | Valid |
|---|---|---|---|---|---|---|
| bike | Charateristics . . . | Details . . . | Price | Place | Valid since | until |
| RS750 | . . . | . . . | 5000 | Fontainebleau | Mar. 23, 2007 | null |
| | | | | | 17:00 | |
| . . . | | | | | | |

When an end user visits the site of Yamazuki, and visualize the data about the type of motor bike which is the one that the private person put on sale, the offer of the private person will only be presented to her spontaneously if the number of times that “I sell” was combined with “Yamazuki” is relatively important.

In the contrary case, i.e. even if there are too many sources to combine with the Yamazuki source for this type of motor bike, in competition with the source “I sell”, the offer of the private person will still be presented by default

if in the same browsing session the end user is interested in the place “Fontainebleau” which is the place of sale of this motor bike. Indeed the competition for the data sources that can be combined with the Yamazuki source (for motor bike RS750) will then be greatly reduced.

The precise scenario can be the following: the end user accesses in the same session not only the source “Yamazuki” but also a source “Chateaux” (castle in French) in which she selects¹⁵ the Fontainebleau row (since there is a famous castle at Fontainebleau). In this case, insofar as the source “I sell” is candidate to be combined with both of these two sites, the influence of each adds up (depending on the implementation, their respective weights can even multiply), and as a consequence the weight of the combination with “I sell” climbs up and hence the offer of the motor bike of the private person is spontaneously presented to the end user: ¹⁵ (e.g. she filters on)

[symbol]

Yamazuki + Châteaux + I sell

[symbol]

| Type of motor | | | | | | Valid |
|---|---|---|---|---|---|---|
| bike | Caratéristiques . . . | Place | Details . . . | Price | Valid since | until |
| RS750 | . . . | Fontainebleau | . . . | 5000 | Mar. 23, 2007 | null |
| | | | | | 17:00 | |

The method of enrichment of selections obtained respectively from the data sources accessed in the same browsing session, making it possible to implement the example above, is described later in this text.

In an even finer way, the content itself of the data presented can be taken into account in the countings. Let us consider the simple¹⁶ example according to which the values of a particular column are taken into account in the countings. A user accesses on the Web a search engine and provides to it to a key word “fly”. An extractor¹⁷ presents, in the form of a table, the result returned by the search engine¹⁸, as follows: ¹⁶ (and that can be sophisticated, see below the example with the regular expressions)¹⁷ The implementation of extractors of data from Web sites is described later.¹⁸ (which becomes thus a data source within the meaning of the present invention)

[symbol]

Search engine

[symbol]

| | | | | Valid |
|---|---|---|---|---|
| Key word | URL | Domain | Valid since | until |
| fly | . . . | Fly fishing | Mar. 23, 2007 | null |
| | | | 17:00 | |
| . . . | | | | |

Let us suppose here that the search engine provides, in a column “Domain”, the field of interest detected (here “Fly fishing”) corresponding to the key word (“fly”) given. If a number relatively large of users had combined, while visualizing precisely the value “Fly fishing” while using this “Search engine” site, the source “Seller1” (let's assume that “Seller1” is a books seller specialized in “Fly fishing”), the latter will be automatically combined (again thanks to countings):

[symbol]

Search engine + Seller1

[symbol]

| | | | Principal | | | | | Valid |
|---|---|---|---|---|---|---|---|---|
| Key word | URL | Domain | author | Title | Seller | Price | Valid since | until |
| fly | . . . | Fly fishing | Author1 | Title1 | Seller1 | 25 | Mar. 23, 2007 | null |
| | | | | | | | 17:00 | |
| . . . | | | | | | | | |

With each data source¹⁹ is associated the degree of the granularity of information to take into account in the countings. ¹⁹ (or each extractor)

Let's now see another example in order to introduce another method of suggestion which does not reflect only one previous case of mapping, but an implicit chain of several previous cases of mappings.

In the table “My articles” below, a user associates an article (“Title10”, “Author10”) with a book (“Author1”, “Title1”) which she regards as being very “popular” in the field of the article.

[symbol]

My articles

[symbol]

| | | | | | Deliver | | | |
|---|---|---|---|---|---|---|---|---|
| Article | Article First | | | Date | Principal | Deliver | Valid | Valid |
| Title | Author | Review | URL | Publication | author | Title | since | until |
| Title10 | Author10 | Revue10 | Url10 | June 2006 | Author1 | Title1 | Mar. 23, 2007 | null |
| | | | | | | | 16:00 | |

She then maps the columns “Book Principal author” and “Book Title” (which identify the said very popular book in “My articles”) with the columns “Principal author” and “Title” of the data source “Seller1”.²⁰ ²⁰ It should be noted that it is supposed here that the user has in addition hidden the columns “Seller” and “Price”.

[symbol]

Seller1 + My articles

[symbol]

| Principal | | | | | | | | |
|---|---|---|---|---|---|---|---|---|
| author (Book | Title | | Article | | | | | |
| Principal | (Book | Article | First | | | Date | Valid | Valid |
| author) | Title) | Title | Author | Review | URL | Publication | since | until |
| Author1 | Title1 | Title10 | Author10 | Revue10 | Url10 | June 2006 | Mar. 23, 2007 | |
| | | | | | | | 16:00 | |

Thus, like already described, when later the user accesses the source “Seller1” and is interested in this same book, its combination with “My articles” is recalled to her automatically and the article “Title10” “Author10” is presented to her.

But even when the user accesses another source (say “Seller2”) for which the combination with “Seller1” would have been automatically suggested, its source “My articles” can²¹ be suggested to her. ²¹ (according to preponderance rules)

Indeed, this is justified by the fact that “My articles” would in any case be suggested to her to be combined indirectly via²² “Seller1” (and the user could simply have made disappear the rows and hide all the columns coming from “Seller1” to be in the same case). ²² A chain of longer indirection is thus also possible.

Thus, a “chain of mappings” existing between “Seller2” and “My articles”, and the mapping of “Seller1” with “My articles” being privileged (strong weight) because being established by the user himself, it will be automatically combined by default. The source “My articles” is thus recalled to the user even if she doesn't remember anymore neither its name, nor even the name of the source “Seller1” with which she had associated (combined) it.

Obviously, according to the rules of preponderance used, the combination of “My articles” with “Seller1” or “Seller2” will be also suggested to the other users, insofar as they can access the sources in question.²³ ²³ Moreover, we did not consider in the latter example the finer grain approaches as we did in the previous examples, which we could of course do.

The functionalities illustrated up to now have been made possible thanks to a mechanism of combination of multidimensional data sources, extractors (and synthetizers) of such data, in particular from Web sites, and of management of the recursive structure of their multivalued attributes²⁴ (in the sense that the values of a multivalued attribute can themselves have a multivalued attribute), that we will now describe and illustrate more. ²⁴ (i.e. dimensions, columns)

We will use the concept of tag with two parts (column and value), which we will call “col:val” (or simply value); the concept of relation between a plurality of col:val, which we will call “row”²⁵; and the concept of sets of rows (such as a table of a relational data base, each row then being a row of the table) which we will call “table”. ²⁵ (such as a row of table of relational data base, each col:value being then a value val in a column col of a row of the table—each row implicitly includes a col:val having the value “null” for each column which has not been mentioned)

Example of a table of two simple rows, each having three values:
1. Principal author:A, Title:C, Price:10
2. Title:C, Price:15, Editor:D

Same table presented in tabular form:

| Principal author | Title | Price | Editor |
|---|---|---|---|
| A | C | 10 | null |
| null | C | 15 | D |

We also will use the concept of “modification row” which specifies a modification of rows, by on the one hand a set of col:val given as “Key” and in addition a set of col:val “Non key” given as substitution values during the combinations.

Example of a table of two rows of modification
1. Key—Principal author:A, Title:B; Non key—Title:C, Price:10
2. Key—Title:C; Non key—Price:15, Editor:D
   or in tabular form:

| | |
|---|---|
| Key | Non key (modification) |

| Principal author | Title | Title | Price | Editor |
|---|---|---|---|---|
| A | B | C | 10 | null |
| null | C | null | 15 | D |

A “modifications table” is a table of modification rows and a “simple table” is a table of simple rows.

Any modifications table can be seen as a table of simple rows. This is done by seeing each modification row as a row made up of the given nonkey col:val and with, for the col:val not included in the set of the given col:nonkey value, by given col:key value. For example the first table presented herebefore represents a table of simple rows drawn from the modifications table which follows it.²⁶ ²⁶ A particular case of row of modification is the case of row not including any key value, and a particular case of a table of modification is the case where there is no key column.

For an information source able to present simple rows, knowing its primary key (i.e. columns uniquely identifying its rows), it is possible to extract from it the rows of modification. ²⁷ ²⁷ It will be seen later that this is implemented in the extractors.

### EXAMPLE

Consider a table of simple rows representing a list of books, for which one knows in addition that the first two columns represent the primary key:

| Principal author | Title | Price |
|---|---|---|
| A | B | 10 |
| C | D | 25 |

Here is the view in the form of a modifications table:

| Key | | Not key |
|---|---|---|
| Principal author | Title | Price |
| A | B | 10 |
| C | D | 25 |

A simple table (called first table) can be combined with a modifications table (called second table) by using the key values of each row of the second table to give, according to actions carried out using a user interface on representations of the columns of the first table and second table, to associations between the rows of the first table and the rows of the second table, by combining the values of the first table with at least a part of, also determined in function of the said actions, non-key values of the second table, and by arranging the non-key values combined with preexistent values also in function of the said actions. The said actions are manipulations (such as drag-and-drop, as already described) of a representation of at least one column of the second table to map it with a representation of at least one column of the first table (or to insert it between two columns of the first table), the columns corresponding to the manipulated representations determining either the said associations between rows, or the said arrangement of non-key values of the second table with values of the first table, according to whether the column of the second table corresponding to the manipulated representation contains or not key values.

Conditions can be associated with columns key and memorized in the form of meta-data. In the example of table “Seller4” given previously (and reproduced below²⁸) including the columns “Number of pages Min”, “Number of pages Max”, “Rating”, “Seller” and “Price”, with the first two columns were associated a condition expressing that the number of pages must be between the values given in these the first two columns. The user who seeks to map a column (which for example would be labeled “#pages”) of a first table with a column of table “Seller4” is then invited to map it with the couple of columns “Number of pages Min”, “Number of pages max” instead of only one column. ²⁹ ²⁸ (in a table with key, an implicit temporal column “Valid since” exists in addition for each column, as described below)²⁹ These conditions are then checked at the time of the join of the tables with key described hereafter.

| Key | | | Not Key | | | |
|---|---|---|---|---|---|---|
| Many Min | Number of pages | | | | | Valid |
| pages | max | Rating | Seller | Price | Valid since | until |
| 300 | 400 | *** | Seller4 | 23 | Mar. 22, 2007 | null |
| | | | | | 10:01 | |
| 400 | 500 | ** | Seller4 | 22 | Mar. 23, 2007 | null |
| | | | | | 14:14 | |

In addition to the conditions, the meta-data can contain actions. The row below indicates that if condition: the value in question corresponds to the expression “*Everest*8? 844*”, then action: to transform it according to the expression “*Everest*8? 844<red>[Everest: 8 844,43 m]</red>] *”.

| Key | Not key |
|---|---|
| To find | To replace |

*Everest*8? 844*|*Everest*8? 844<red>[Everest: 8 844,43 m]</red>]*

Lastly, the meta-data can comprise global-level indications and conditions on the data sources to be combined.

Two information sources being given, the first source being able to provide a table of simple rows (or a modifications table seen as a table of simple rows), the second source able to provide a modifications table, a mapping being established between at least one column of the second table (i.e the table provided by the second source) and at least one column of the first table (i.e the table provided by the first source), the rows of the said tables could be combined whenever all the key values of the second table are thus mapped with columns of the first table (even in the absence of values, i.e. even if they have a null value in the first table) and, if values are missing in the first table for these mapped columns, if key columns are given for the first table taken as a whole³⁰, all the col:key values of the first table were mapped. This checking can be carried out by a preprocessor, before the implementation of the method of combination of the tables itself described below. ³⁰ It will be seen that the information of the key columns can be thus associated with an extractor of data.

With each value a validity start is associated (i.e time of first appearance or beginning of belief of this value). With each row is associated a period of validity: the validity start of the row is equal to the greatest time of validity start associated with a value of the row, and the validity end of the row is its time of last appearance³¹ (or time of end of belief of this data). An end of null validity means that the data is always valid (i.e value always published by its source or always believed). ³¹ (which generally requires to be confirmed after a period of uncertainty)

In a table the rows are filtered according to the temporal cursor positioned by the user (as illustrated by the examples given in the beginning): only the rows having a time of validity start lower and a time of validity end superior or equal to the time indicated by the cursor are retained (the time of the cursor indicates the time of belief and only the data believed at the positioned time are considered).

The implementation of the combination of tables uses the concept of “table with key”. Any table can be transformed into a relational table, called “table with key”, where all the columns that can be used as key appear as additional column and contain the value of the key for the row in question.

The implementation of the Method of combination of a second table with a first table consists in adding to the first table the result of a relational join between tables with key corresponding to the first and the second tables (respectively called first and second tables with key). This join is carried out on the key values that are in the columns of the second table with key³² mapped by the user³³ by taking into account the conditions³⁴ and/or associated actions, if any, which are in the meta-data (as described above); by providing the said key values with, for each one, the greatest value of validity start³⁵ and, for the other values of the mapped columns, by providing the existing values having the largest validity start³⁶, the values of validity start associated with the said provided values being those they had before combination; the rows of the said tables with key being filtered compared to positioned time (temporal cursor, as described above). ³² (by “column of table with key” we mean the corresponding columns in the corresponding table)³³ (or by acceptance of an automatic suggestions of mappings of columns)³⁴ (for example in the form of “Where” or “Having” in SQL)³⁵ (between the value of beginning of validity of the said the key value in the first table with key and the value of beginning of validity of the said key value in the second table with key)³⁶ In other words, between the first and second tables, for each nonkey column, when the value exists on the two sides it is the most recent value which is taken. Information is thus supplemented in time. Thus, to obtain the values “Price” (as presented in the preceding examples), in SQL the clause SELECT will comprise a part CASE WHEN Table2. [Prix_ValidStill]>Table1. [Prix_ValidSince] THEN ISNULL (Table2.Price, Table1.Price) ELSE ISNULL (Table1.Price, Table2.Price) END AS Price.

The method of expansion/collapsing described later makes it possible to present to the user only the most recent data (by reducing the column “Validity start”, like earlier illustrated in the examples).

When a result of combination of tables is combined in its turn (in cascade), only the most recent rows with respect to the positioned time (temporal cursor) are taken into account.

Let us now consider that in general the user who accesses a data source does not visualize all the data of it at the same time, but just a selection. Here we describe a method of enrichment of selections obtained respectively from the data sources accesses in the same session. This method is implemented by using the method of combination of tables described above and can be seen as an improvement.

Let us consider that the user accesses first the second source and then the first source.

Let us call “first selection” the selection of data in the first source and “second selection” the selection of data in the second source.

After the presentation to the user of a selection of data from a second source³⁷, at the time of the presentation to the user, in the same session, of a selection of data from a first source³⁸, a mapping of at least one dimension having been made³⁹ between the two sources, the first selection will be “enriched by the second and first sources”, namely: it will be enriched by the “combination” of the second source with it and it will be enriched by adding to it the “combination” of the second selection with the first source entirely taken except the content of the first selection (since the latter was already combined with the second source taken in entirety); by “combination” we mean the method of combination already described above. ³⁷ (said “second selection”)³⁸ (said “first selection”)³⁹ (explicitly made, or applied by default, or suggested then accepted; we mean the same every time we speak about mapping)

Then, when the user accesses a third source (and that a third selection is thus presented to her), if a mapping of at least one dimension were made⁴⁰ with the source of the previous selection (here the first), the same method is directly applied (to be noted that if⁴¹ the previous selection, here the first, had not been enriched with the one before the previous one, here the second, and that a mapping of at least one dimension had been made with the latter, the same method should also be applied to enrich the third selection with the second and third sources), if not, if a mapping of at least one dimension were made with the one before the preceding one, here the second, the same method is applied to enrich the third selection from the second and third sources, if not as in this example no other source was accessed in the current session, the third selection is not enriched. ⁴⁰ (and that the mapped columns are able to cover the key values of the preceding source, at least of the preceding selection; we mean the same every time we speak about mapping)⁴¹ (which is not the case in this example)

Thus, while generalizing with the case of n selections:

When the user accesses a current source and that a current selection is presented to her by that source and that in the same session the user had accessed a preceding source and that a selection had also been presented to her by that preceding source, IF a mapping of at least one dimension were made with the preceding source, the current selection is enriched by the preceding and current sources (see hereafter the definition of these terms) and optionally, if the user in the same session accessed a source before the preceding one and that a selection was presented to her, if the preceding selection itself had not been enriched with the one before the preceding one, if a mapping of at least one dimension were made between the latter and the current source, the current selection is enriched with the sources before the current and the preceding ones, and so on until the beginning of the session, ELSE

IF the user in the same session accessed a source before the preceding one and that a selection was presented to her, if a mapping of at least one dimension were made between the said source before the preceding one and the current source, the current selection is enriched by the said source before the preceding one and the current source and optionally, if the user in the same session accessed a source before “the source before the preceding one” and that a selection was presented to her, if the selection before the preceding one itself had not been enriched with that before “that before the preceding one”, if one mapping of at least one dimension was made between the latter and the current source, the current selection is enriched with the sources before the current preceding one and, and so on until the beginning of the session,
IF NOT a preceding source is considered and so on until there was a mapping of at least one dimension between a preceding source and the current source or that there was not any more other source previously accessed by the user in the same session.

The said enrichment of the current selection from a preceding source and current source consists in adding to the current selection
combination of the said preceding source with the current selection and
combination of the preceding selection with the current source from which the current selection was withdrawn.

It should be noted that the method above is also applicable in the case of an empty selection⁴². This is for example the case when, within a succession of access to Web sites providing data (seen as data sources through an extractor, as described later), the user visits the home page of a Web site instead of accessing directly a specific page of the site (which would directly provide a selection of data). ⁴² Combination of a source with an empty selection resulting simply in an empty table.

By session we understand a succession of access by the user to data sources whose combination is potentially relevant. Typically, we will consider that the accesses that are close one to another in time are in a same session. A particular Implementation consists in partitioning the accessed sources according to their mapped dimensions⁴³. ⁴³ Advantageously one will consider together (in the same session) the sources accessed by the user for which mappings of columns were suggested to the user and that the user did not reject.

We will now describe a method of extraction/synthesis of data which will make it possible to carry out the combinations (enrichments of selections) and expansions directly at the level of the Web pages. FIG. 11 presents schematically on the left a page of results of a site selling books, grouped by authors and on the right the table resulting from its extraction⁴⁴. ⁴⁴ It is seen that the column “author” repeats the names of authors as much as necessary, we will later see how to avoid this problem thanks to the method of expand/collapse corresponding to the sixth aspect of the invention.

The user who creates an extractor associates it meta-data in which she can in particular indicate which are the key columns⁴⁵ of the extracted table. She can indicate several options of them. Thus for the example of FIG. 11 she can indicate option1: the column “ISBN”, and option2: the couple of columns “Author” and “Title”. During each combination the system will then choose the first option (in the order of the options given) which belongs to the mapped column(s). For example, if the end user mapped “Author” and “Title” during a combination, it is the second option which will be selected. ⁴⁵ (or key columns “by default” if values of these columns can be null)

An extractor provides a table (simple or modifications) starting from the data coming from a Web page. It must thus indicate on the one hand the request (URL, parameters GET or POST) and on the other hand how to extract the data of the page. It can also manage the pagination and download several pages of results automatically.

The method of creation of an extractor, starting from a Web page containing a set of multidimensional data, is semi-automatic. First of all, the user selects in the Web page one or more objects each corresponding to a row of the table, and indicates which object of the page corresponds to which row of the table to generate. The system compares the paths of these objects and classically build a generic path (Xpath) covering at least the objects indicated by the user.⁴⁶ the system can thus determine the values for each object, and present the thus obtained table to the user. ⁴⁶ In a preferred implementation, all the objects corresponding to the path thus built are highlighted and the user can refine the path by indicating additional objects or by unselecting highlighted objects. The system then refines the Xpath to respect these constraints. When the user is satisfied with the selection of objects, she specifies for one of these objects (the “model object”) all the attributes which will correspond to the columns of the table. For each attribute, an object in the page, a name of column and, if necessary, HTML attribute to be extracted (for example, for the links, it has the choice between the value of the attribute href or the text of the link). The system establishes, for each attribute, a pair (name of column; Xpath), the path being related to the model object, and records this information in the extractor.

The synthetizer is the reverse of the extractor. It is created automatically at the time of the creation of the corresponding extractor and makes it possible to display the data of a table in the style of presentation of the Web page, the graphic zones being placed at the location of the objects containing the values of the table to make it possible to expand them or expand/collapse them to map columns of various tables corresponding to various Web pages (i.e with various combined sites as we describe it later). It is created as follows: the user chooses a model object corresponding to a row of the table⁴⁷. All the objects corresponding to other rows of the table are withdrawn from the page and all the objects referred by objects corresponding to rows of the table but not by the model object are removed. The values contained in the model object are modified to correspond to the first row of the table, and a copy of the object is inserted after it with the values of each other row to display. ⁴⁸ ⁴⁷ (that have been used as model at the moment of creation of the extractor, as described in the preceding note)⁴⁸ More precisely, let us call “synthesized object” the smallest object containing the model object as well as all the objects corresponding to an attribute of the model row (let us call these objects “attribute objects”), and let o1, o2, . . . , oN be the sequence of objects of which each one is parent of the following, the first is equal to the synthesized object and the last equal to the model object. A copy of the synthesized object is carried out, then (in the document itself) its attributes objects are modified to correspond to the first displayed row of the table. For each row of the table, in the synthesized object, the largest I (with 1≦I≦N) is determined such as oI contains all the attribute objects corresponding to nonempty cells of the current row. A copy of oI (and thus also of for all the J>I) is created, its attribute objects are modified to reflect the current row, and is inserted (as sibling) after the last copy of oI to be placed in the document. The user can request to modify a synthetizer. The same method above is then applied by being based on a table of one row containing the names of the columns instead of values, with special markers making it possible to distinguish them from normal text (for example, “${author}” in the author column, and so on). The model object is located using special markers (for example <model-object> . . . </model-object>). The user can modify the resulting document in her own way, for example using a text editor, and returns it to the system. To display the synthesized page, the above method uses from now on this new structure (provided that there is exactly one zone delimited by the markers of model object). However she is authorized to remove or duplicate markers of attributes. She can remove the display of an attribute which she considers not very important, and an example of duplication is to place an attribute once inside the model object and once outside, in order to have a heading using this attribute, while displaying the value of the attribute to each row of the displayed list. Another application is to put same “URL” value as both text and address of a hypertext link (i.e <a href=“$url”>$url</a>).

We will now briefly introduce the method of expand/collapse with a schematic example of a table presenting a list of books having the “Photo”, “Author”, “ISBN”, “Title” and “Language” Columns.

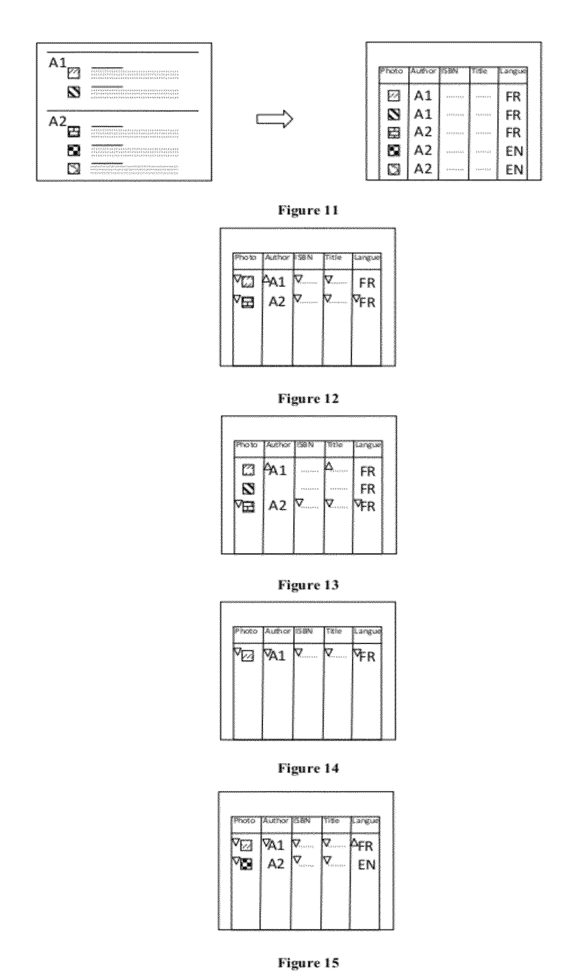

In FIG. 12, only the column “author” is expanded, so as many rows as there are different authors are displayed. Here as all the authors have more than one book, expand buttons (represented as a triangle directed downwards) allow to display the list of the books written by a given author.

The display presented in FIG. 13 is obtained by clicking the expand button associated to the Title cell of the first row, this button meaning here “to expand the list of the titles of the author A1”. As the Author column was already expanded, it is obvious that the cells of this column, in the rows thus expanded, will all have the value A1. In order to have a better user interface, A1 is thus indicated only in the first of the expanded rows, the other rows leaving this blank cell.

If now the user clicks on the button “to collapse the list of the authors” (triangle directed upwards), all the table is collapsed to only one row as indicated in FIG. 14. Expand buttons “indicate that there exists more than one author, more than one book, more than one language, etc (FIG. 14).

Then, in FIG. 15, the user expanded the list of the languages. There is no expand button at the level of A2 since in this example there is no other author than A2 having written a book in English.

The same functionality is available when a synthetizer is used: the expand and collapse buttons and are placed at the location of the object containing the value of the cell.

However certain synthetizers are better adapted to a given order of expansion. For example a synthetizer primarily displaying (highlighting) the authors is more adapted to an expansion of the Author column first. We will now describe a method for the selection of a suitable synthetizer for a given order of expansion of columns.

For a given synthetizer, with each column (displayed at least once) can be associated the smallest oI object (and thus the largest I, with 1≦I≦N) containing all the attribute markers corresponding to this column. This makes it possible to order the columns according to the importance being allotted to them by the synthetizer (a small value of I indicates a higher importance). One can thus estimate how much a synthetizer is adapted for an order of expansion of columns, by comparing the order of expansion with the order of importance of these columns according to the synthetizer. When the system gives the list of the synthetizers for a given source, this list can be sorted according to this criterion, according to expansions already carried out by the user, in order to allow the selection of the synthetizer.

So the method of enrichment of selections obtained respectively from the data sources accessed in the same session can be applied to selections directly visualized in Web pages playing the role of data sources (through extractors). The mappings of columns can be made by the user directly on presentation of these data sources (through synthetizers) in the form of Web pages.

Two sources being thus displayed in the form of Web pages which are positioned in an adjacent way, the user simply drag-and-drops a value of a Web page on a value of another Web page to map the columns to which these values belong.

Now we describe the method of expand/collapse in detail. We assume here the existence of a device providing an interface similar to the user interface of a database server and giving access to the displayed table. In the rest we call this device the data source.

The data source stores a “table” which is a data structure having a certain number of “columns” and “rows”, and where each row has some content for each column. In general, the rows represent entities of information and the columns represent properties of these entities, and it frequently happens that for some columns, there is the same value in several rows. This happens for example in the case where a property of a same entity can by nature have several values (it is said that it is “multivalued”). When there are no ambiguities, “the table” refers to the table provided by the data source.

To make it possible to reduce the quantity of information presented, the interface will provide means for applying filters to the rows (or, in other words, it will provide means for carrying out a search in the table). When a given filter allows the user to select rows having a specific value in a certain column, it is said that the value of this column “is specified”. In a more general way, it can also be possible to impose constraints (i.e. “to specify” a value for a column is a particular case of constraint). For example a filter can select the rows containing a given word in a column. When the value of a column is constrained, a row which doesn't have a consistent value (i.e. with respect to the constraint expressed in relation to this column in this row) will not be shown in the displayed table. In the following, for sake of conciseness we may suppose that no filter is applied. Indeed, treating the filters in the implementation is trivial: it is enough to add them to the conditions produced by the algorithm (described later) at the time of each access to the table.

The method of the invention allows, in the presence of multivalued properties, to replace with only one row the rows having the same respective values in a set of given columns (called “expanded” columns).

Displaying rows having a certain number of columns that are collapsed and other columns that are not collapsed, is primarily carried out as follows: a row (called hereafter “displayed rows” as opposed to the rows of the table) is displayed for each combination of values existing in the table in the expanded columns. For each displayed row and “collapsed” column, if there exist only one possible value according to the table, this value is presented, otherwise one of the existing values is presented⁴⁹; alternatively, the number of existing values or any function of the existing values⁵⁰ is presented, and a button makes it possible to expand these values. ⁴⁹ This is the option taken in the description and the examples presented hereafter.⁵⁰ (such as a comma separated list of the existing values, or an aggregation function of the existing values if the values in question are numbers)

More precisely, assuming that the columns of the table represent the different types of data, and the rows represent the data (tuples) having the respective types, for certain rows the presentation of certain columns⁵¹ can be done in “expanded” mode and the displayed rows then comprise the following characteristics: ⁵¹(i.e. certain cells of the rows in question)
1. Each displayed row represents the subset of the tuples (of the table) respectively having the values presented in the expanded columns. ⁵² ⁵² The subsets corresponding to the displayed rows are disjoined.
2. In each displayed row, in association with each not expanded column, an “expand” button is displayed if in the table there exists at least two tuples which have
   a. different values in the said (not expanded) column
   b. and same value (same as the value displayed in the said displayed row) in each expanded columns.
3. When the user positions the cursor of the mouse on the “expand” button (i.e. when the mouse rolls over it), the list of the values existing for the column in question (among the tuples having the same values for the expanded columns), can be displayed (in a “pop-up”).
4. The user can then click one of the values displayed in the said pop-up. This will then cause the values presented in the row containing the said “expand” button to possibly change in order to show a tuple having the value chosen in the column in question. We call this operation the “rotation” of the row.
5. When the user clicks⁵³ an “expand” button presented in a displayed row as described in point 2, the tuples (having different values for the column where the expand button has been clicked and the same values for the expanded columns) are displayed⁵⁴ and then ⁵³ Of course, any analogous (appropriate) action carried out by the user on any kind of (appropriate) user interface can be adopted to implement the method of this invention.⁵⁴ In these expanded rows there is now an additional expanded column.
   a. a “collapse” button replaces the said “expand” button
   b. (as already said at point 2.) for each row thus expanded, an “expand” button is displayed in association with each non-expanded column for which there exists in the table at least two tuples which have different values in the said non-expanded column and same value (same as the value displayed in the said expanded row) in each expanded columns.
6. In cascade, it is then possible to expand the cells of the expanded rows as described above (in the point 5.), and so on and so forth until obtaining a displayed table not comprising anymore “expand” button and whose displayed rows correspond exactly to the rows of the table.
7. One can imagine that there exists in addition one expanded virtual column called “row” (gathering all the rows) and hence that initially only one row representing all the rows of the table can be displayed with “expand” buttons appearing in association with each column for which there exists in the table at least two tuples having different values in that column.
8. Clicking the “collapse” button has the effect of cancelling the expansion that caused its presentation (described at the point 5.a), as well as all the expansions in the correspondingly expanded rows. The collapse button will typically be placed at the same place as the button having been used to expand a cell, so that clicking twice on an expand button allows to briefly see the rows corresponding to a displayed row.
9. Instead of placing only one collapse button for an expansion already carried out (i.e. instead of placing it only at the level of the first row among the resulting rows) such a button can be placed at each row thus expanded, in order to simulate the effect of a collapse followed of one (or several) rotation (we call this “global rotation”), the goal being that collapsing can be carried out by clicking the collapse button at the level of any expanded row and that, as a consequence, the values shown in the unique row resulting from collapsing are the same as the values that were in the row at the level of which the collapse button have been used.
10. For each column, the user can choose an aggregation function to represent the collapsed cells.
11. Means can be offered to select several expand or collapse buttons at once and to activate them in one click.
12. Within the headings of the columns user interface components are associated to the columns in order to make it possible to change the ordering of the columns and to hide/show or remove columns.
13. The user has also means to provide a “filter” on the rows to be displayed in the table. For example to show only the rows that have a certain value in a certain column, or that have two given columns being equal, or even corresponding to an arbitrary SQL expression (i.e with giving any valid expression which is a parameter of WHERE or HAVING, by taking of course the usual precautions to prevent prohibited accesses) given by the user.
14. A functionality will be provided “to hide the other values” for the cells of the expanded columns, similar to collapse, but which behaves as if the cell remained expanded. Also a means of changing the displayed value (by “rotation”) or of leaving this state can be provided.

By “sub-table” we mean the set of the cells newly displayed as described in point 5 above.

With a table of displayed rows is associated the following information (constituting a structure of the type “state of table of displayed rows”)
A set c1, c2, . . . of columns to be shown,
an association column->value f1->v1, f2->v2, . . . for each specified value⁵⁵, ⁵⁵ As mentioned before we consider the queries in the case of specified values (f1=v1 . . . ), the approach of the described mechanisms is valid for the case of constrained values.
a set of expanded columns d1->t1, d2->t2, . . . , the values ti, which are optional, indicate in the list of the displayed rows, which one is placed first (we speak about “total rotation”, see point 9. above where this concept was introduced)
for each row, an ordered set of rotations, each one represented by a pair column->value ri->wi, corresponding to the values selected by the user as said in point 4. above. The order corresponds to the chronological order of the rotations carried out, and contains only the associations whose result is still visible: if a rotation cancels the effect of another, the latter and those preceding it are withdrawn from the list.
a set of sub-tables, also described as a structure of the type “state of table of displayed rows” (as described hereafter).

The displayed data correspond to a SQL query “SELECT c1, c2, . . . WHERE f1=v1 AND f2=v2 AND . . . GROUP BY d1, d2, . . . ” (the rows that include rotations having to be adapted as described below), followed by similar queries for each sub-table.

If a column ci uses an aggregation function a and ci is not expanded, then the query contains a(ci) instead of ci.

A new rotation of a column r to a value w in a displayed row L is treated as follows: add the pair r->w at the end of the list of rotations, to obtain r1->w1, r2->w2, . . . , rn->wn, r->w. Then add this sequence to the specified columns, as well as the association of the expanded columns d1, d2, . . . with the values which they take in the row L. If at least one row is found, its values are displayed for L. Otherwise, the first association (r1->w1) is withdrawn from the table T, and the process starts again, until at least one row is found.

When in a table T, a cell of a displayed row L and a of a collapsed column C is expanded, a new table T′ is inserted in the list of the sub-tables of T, with the following parameters:

The columns to be shown are c1, c2, . . . , the same ones as T; the specified values of the sub-table are f1->v1, f2->v2, . . . , d1->L(d1), d2->L(d2), . . . , those of T plus the values of L for the expanded columns; the expanded columns of T′ are d1, d2, . . . , C, the same ones as those of the table containing L plus the column C. The rotations indicated by T for the row L are withdrawn from T, and are placed in T′, for the same row, except, if it is the case, of a rotation of the column C for the row L which is recorded as global rotation parameter for C.

T′ therefore represents all the rows of the table corresponding to L.

Several alternatives can be used in the interface to represent a sub-table T′:
1. It can be shown over T, as a “pop-up”,
2. It can be inserted instead of the row L (shifting the displayed rows of T following L), by distinguishing it from the others with a border,⁵⁶
3. It can be inserted instead of the row L, by distinguishing it from the others by a change of colors.

Collapsing a table T′, which is a sub-table of a table T and expands the cell at the column C of a row L, is carried out by:
1. withdrawing T′ from the list of the sub-tables of T;
2. adding to the list of rotations of the row that T′ replaced the set of rotations, which are in T′ and its sub-tables, and correspond to the row which is at the level of the collapse button used. These rotations are ordered by respecting the order given in the sub-tables, and by placing first those that are in the deepest sub-tables;
3. If the collapse button were not the one of the first row but at the level of a value v, a rotation c->v is added at end of the rotation list of the row L.

Since the volume of the data in the table is typically too large to be completely downloaded at once from the data source, only the data that currently has to be displayed to the user are required. When the user carries out an expansion (or a change in the filtering rules), the system queries the data source to obtain only the information which is not yet visible by the user.

For collapsing a set of rows, no information must be required to the data source since all the necessary information is already present: in order to determine which cell must contain an expand button it is enough to traverse the corresponding column in the sub-table to collapse, and check if it contains cells having an expand button or if two cells have a different value.

Alternatively, on expand of a set of rows, the state of the row before expansion is recorded in order to be able to restore it at the time of collapse. The operation of “rotating collapse” (as described before) will at most change the values in the row, not the existence or not of expand buttons.

During the expansion of a set of rows, a query is sent to the data source, containing the properties of the sub-table that is about to be created (i.e. columns, specified values and rotation information). ⁵⁶ It is not necessary that T′ contains all the columns: the values of the specified columns are already visible in the parent table and can be omitted in the sub-table in order to reduce posting. However in order to avoid, in the variants 1. and 2., to have “holes” in the sub-table caused by these omitted columns (in order to preserve alignment with the root table i.e. the table which is not sub-table of any other), one could possibly impose that the columns shown in the sub-tables are a contiguous interval of the columns shown in table root.

The data source may determine the content of the sub-table (i.e. the values to be shown, and the set of the cells having to have an expand button), and returns it to the user.

The received data replace the row containing the button which have been clicked by the user.

In order to avoid losing data on collapsing rows (which would require to ask them again to the server when/if the user expands the columns again), it is possible to preserve the set of the sub-tables having been created, and simply make them visible again when the user carries out an expansion to display a sub-table that has already been built. In this approach, with each expand button a reference to the sub-table can be associated in order to make it visible when the said button is activated. When a button is activated for the first time, a sub-table is created as described above, and a reference to it is recorded in relation to expand the button. When the sub-table is collapsed, it is simply made invisible, and the collapsed row is made visible. If the user uses the expand button again, the reference to the sub-table is used, and the sub-table is simply made visible again.

To be noted that, during the expansion of a row, even if the first row of the sub-table contains the same values as in the collapsed row, the expand buttons are different objects, and thus have their own reference to a corresponding sub-table. This makes it possible to preserve in parallel the different expansion orders of the cells.

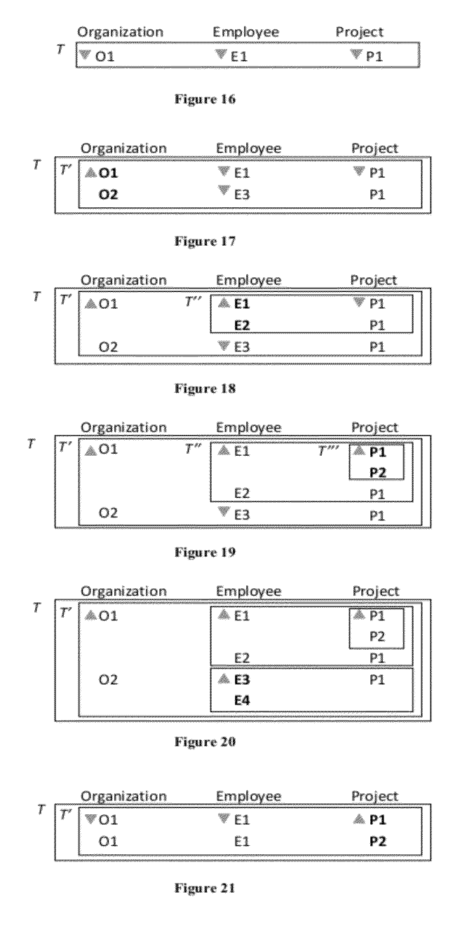

In FIGS. 16 to 33 let us consider the following data source providing 5 rows of 3 columns:

| Organization | Employed | Project |
|---|---|---|
| O1 | E1 | P1 |
| O1 | E1 | P2 |
| O1 | E2 | P1 |
| O2 | E3 | P1 |
| O2 | E4 | P1 |

First of all, FIG. 16 presents the case where all the columns are collapsed. It should be noted that in this example the user interface presents in each collapsed cell one value (rather than indicating for example how many different values this cell stands for, and/or presenting a comma separated list of these values) and that the set of values (O1, E1, P1) shown in the different columns corresponds to a row actually (really) existing in the data source, and so that other implementations are of course possible.

FIG. 17 presents the sub-table T′ presented following the expansion of the column Organization (the user having clicked the button associated to O1) in the unique row which was presented in the preceding example (in FIG. 16). Notice that this button is then replaced by a reverse button which makes it possible to collapse O1 again (and to thus return to the situation of the FIG. 16). In the column Organization, all the existing values (namely: O1 and O2) are then presented, with for each one an associated value presented in each other column, the values presented in each row forming together a tuple that exists in the data source⁵⁷. ⁵⁷ Alternatively (and as already mentioned), instead of (or in addition to) presenting a value in each column one can present a combination or aggregation or cardinality of the existing values or even any other relevant information, or even nothing at all.

FIG. 18 presents the sub-table T″ which appears on click of the button associated with E1 in the preceding example (to expand the employees of the organization O1). It is noticed that there was no need to repeat O1 in the second row, which allows a more pleasant presentation to read⁵⁸. ⁵⁸ (i.e. this value O1 is implicit in the first column of the second row)

FIG. 19 highlights the sub-table T″′ which appears following the click on the button associated with the P1 project on the first row in the preceding example (in order to expand the projects of E1 of O1). And it is seen that E1 is implicit in the second row. ⁵⁹ ⁵⁹ The interface thus presents two trees (hierarchical structures) of which one of the roots is O1, E1 and E2 are its two branches, and where P1 and P2 are the two leaves of E1.

FIG. 20 highlights the sub-table which appears following the click on the button associated with E3 in the preceding example. One now sees the 5 rows of the table of the data source and that there is thus no more cell to expand.

By starting again from the example presented in FIG. 16 (presenting the table entirely collapsed in only one row), the FIG. 21 presents the state of the displayed table following the click of the button associated with P1 (in order to expand the projects). In the column Project, all the existing values (namely: P1 and P2) are then presented, with for each one an associated value presented in each other column.

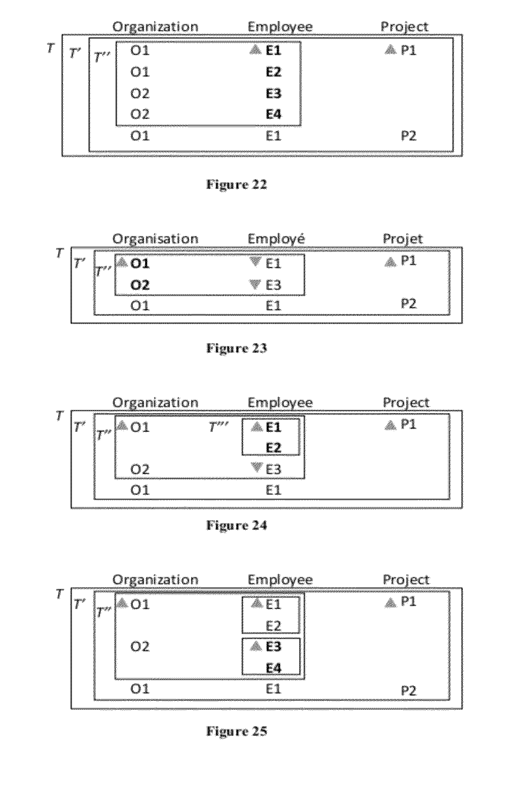

FIG. 22 highlights the sub-table T″′ which appears following the click of the button associated with E1 in the first row in the preceding example (this click aims to expand the employees taking part in the P1 project). The table is then directly expanded completely and thus the button to expand O1 of the first row does not have to be there anymore.

Starting from FIG. 21 the user can also choose to expand the organizations of the first row before expanding the employees, this is what presents FIG. 23. Then, in the FIG. 24, E1 of the first row is expanded, and in the FIG. 25, E3 is expanded to completely display the rows of the data source.

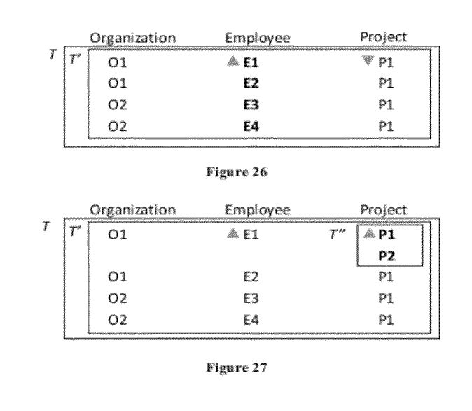

Last, from the first example one can also start by expanding the employees, as shown in the FIG. 26. As for all the rows presented there is no more organization to expand, there is no more expand button in the organization column, on the other hand it remains a project to be shown so there is an expand button on P1 in the first row.

The user can then arrive directly at the table entirely expanded by clicking the expand button associated with P1 in the first row, as shown in the FIG. 27.

1. Method of automatically combining multidimensional data by manipulating their dimensions in a data-processing environment, comprising a data-processing equipment able to access multidimensional data sources, characterized in that it comprises the following steps:
(a) providing a first multidimensional data source;
(b) providing at least one second multidimensional data source, at least in this second source each data having key values and non-key values in its dimensions;
(c) identifying actions carried out using a user interface on representations of certain dimensions of the sources;
(d) depending on the said actions, combining the data sources by using the key values of each data of the second source(s) to carry out associations between the multidimensional data of the first source and the multidimensional data of the second source(s) and thus obtaining combined multidimensional data, the said combination being carried out (i) by adding to the multidimensional data of the first source at least part of the non-key values of the corresponding second data source(s), and (ii) by arranging the added non-key values with respect to preexistent values of the first source for the same combined multidimensional data.

2. Method of automatically combining multidimensional data from a plurality of data sources, characterized in that it includes a succession of executions in cascade of the method of claim 1, the combined data resulting from one execution of the said method constituting a data source for the next execution of the said method.

3. Method according to claim 2, in which the arrangement of the added non-key values with preexistent values for the same combined multidimensional data includes the selection of one non-null value among the values coming from the different sources.

4. Method according to claim 2, in which the arrangement of the added non-key values with respect to preexistent values for the same combined multidimensional data comprises the selection of a value among the values coming from the different sources according to a given decision-making method.

5. Method according to claim 4, in which to each data a period of validity is associated, and in which the decision-making method comprises the selection of a value belonging to a data which is valid on a given date.

6. Method according to claim 4, in which to each data a date of first appearance is associated, and in which the decision-making method comprises the selection of the value from the data that appeared the most recently before a given date.

7. Method according to claim 6, comprising, for the data of a source to which no date of first appearance has been associated, a step of creation of a date of first appearance equal to the date at which the data was involved in a combination of data for the first time.

8. Method according to claim 1, in which at least one of the multidimensional data sources comprises at least two upstream data sources and the information defining a combination previously carried out according to claim 1.

9. Method according to claim 1, in which the said actions are manipulations on a graphical interface of a representation of at least one dimension of the second source in order to map it with a representation of at least one dimension of the first source or to insert it between two dimensions of the first source, these dimensions determining either the said associations between data, or the said arrangements of non-key values of the second source with values of the first source, according to whether the dimension of the second source corresponding to the manipulated representation contains or not key values.

10. Method of combining multidimensional data, comprising the following steps:
providing an access to a plurality of data sources,
memorizing, from combinations carried out by the method of claim 1, mapping of information between data sources
at the time of access a data source which has already been combined with other data source(s), signaling the existence of some or all of the said other data source(s).

11. Method according to claim 10, in which mapping information also comprises the information of dimensions mapping between the said sources and comprising moreover, at the time of an access to a data source having already been combined with other data sources, signaling also the mapping between dimensions.

12. Method according to claim 10 or 11, comprising moreover the execution by default of the method according to claim 1 of combining the accessed data source with the said other data sources.

13. Method according to one of claims 10 to 12, in which information of mapping is memorized for a plurality of users, and the step of signaling is carried out according to rules of preponderance among mapping information.

14. Method of combining multidimensional data, including the following steps:
providing access to a plurality of data sources,
memorizing mapping information between data sources based on the method of combining according to claim 1,
at the time of access to a data source having already been combined with other data sources, determining the existence of a chain of mappings between data sources, and, according to the characteristics of mapping information, to selectively combine according to the method of claim 1 the data source which is accessed and a data source related to it by a chain of at least two mappings.

15. Method of enrichment of multidimensional data by automatic combination based on manipulations on their dimensions in a data-processing environment comprising a data-processing equipment able to access multidimensional data sources, characterized in that it comprises, after having applied to a previous data source a function of selection to obtain a previous selection of data, the following steps:
at the time of access to a current data source in order to obtain a current selection of data, to determine the existence of at least one mapping of dimensions between the two data sources,
if such an existence has been determined, to apply the method of claim 1 to a first pair of first and second data sources made up respectively of the current selection and previous source, and to a second pair of first and second data sources respectively made up of the current source, from whom the current selection is withdrawn, and of the previous selection.

16. Method according to claim 15, in which the mapping of dimensions between the data of the two sources is carried out during the execution of the method.

17. Method according to one of claims 15 and 16, in which the access to the sources is carried out using a Web browser and in what the execution of the method is carried out by intercepting the requests towards servers and by extracting data from these servers.

18. Method according to claims 16 and 17 taken in combination, in which the said mapping is carried out by displaying the selections of data to the user and by capturing the events that the user drags-and-drops values in the dimensions that have to be mapped.

19. Method according to claim 18, further comprising a step of synthesis to display the said selections in their graphic environment and to associate to the values means to enable drag-and-drop.

20. Method according to claim 15, executed repeatedly on accessing a succession of data sources, in which, at the time of accessing a current data source for which there does not exist any dimension mapping with the previous source, the existence of dimensions mapping between the current source and a former source is searched, and the method of enrichment is applied on pairs of sources constituted by the said former source and any source accessed more recently with which there exists a mapping of dimensions, then on a pair of sources constituted by the said former source thus enriched and the current source.

21. Method according to claim 20, executed at the time of the access to a succession of data sources SN-2, SN-1 and SN, including the following steps:
if a mapping between dimensions of sources SN-2 and SN-1 on the one hand, and SN-1, SN on the other hand exists, to execute the method between sources SN and SN-1 by using as source SN-1 the result of the method according to claim 15 executed on sources SN-1 and SN-2,
if no mapping between sources SN-2 and SN-1 exists, to determine if there exists a mapping between dimensions of sources SN-2 and SN and, in the affirmative, to execute the method according to claim 15 on the one hand on sources SN and SN-1 and on the other hand on sources SN and SN-2, and
if no mapping between the sources SN-1 and SN exists, to determine if there exists a mapping between dimensions of sources SN-2 and SN and between sources SN-2 and SN-1 and, in the affirmative, to execute the method according to claim 15 on the one hand on sources SN-1 and SN-2 and on the other hand on sources SN and SN-2.
and so on for sources SN-3, SN-4, etc.

22. Method for manipulating the visualization of a resource containing information structured in the form of a table (array) with at least two dimensions, as obtained in particular by the method of one of the claims 1 to 9 or 12 to 21, where a dimension of the table is constituted by columns representing data types, and another dimension of the table is constituted by rows, each row representing a line of associated data having the respective types, characterized in that the method comprises:
(a) displaying in the form of a single row a group of lines of associated data having all same value in a given column,
(b) displaying, in the given column, the said value, and
(c) displaying, in association with at least one other column, an indicator signaling that there exist at least two values in this other column for the said group of lines.

23. Method according to claim 22, characterized in that it comprises a step consisting, on actions performed by the user using an input user interface with relation to the said other column at the level of the said single row, of causing the display of the different values taken by the group of lines in this other column.

24. Method according to claim 23, characterized in that the said display is carried out value by value.

25. Method according to claim 24, characterized in that the said display is carried out in a pop-up menu or window.

26. Method according to one of claims 22 to 25, characterized in that it further comprises the following step:
(d) in answer to an action performed by the user using an input user interface in relation to the said indicator, the expansion as a sub-table of the said single row.

27. Method according to claim 26, characterized in that the said sub-table comprises as many rows as there exists, in the said group of lines, different values in the said other column.

28. Method according to claim 26 or 27, characterized in that each row of the said sub-table contains a different value in the said other column and represents a sub-group of lines all having this value in the said other column.

29. Method according to one of claims 26 to 28, characterized in that it comprises the repetition of the steps (b) to (d) for at least one of the rows constituting the said sub-table, repetition applied to at least one more other column in which there exist at least two values for the sub-group of lines corresponding to the said row at least.

30. Method according to one of claims 26 to 29, characterized in that there exists a virtual additional type “row”, the table being initially presented in the form of a single row gathering all the rows, an indicator being displayed in association with each column in which there exist at least two values.

31. Method according to one of claims 26 to 30, characterized in that each row of the said sub-table represents, for the columns with the indicators from which the sub-table was formed, a specific combination of different values.

32. Method according to one of claims 26 to 31, characterized in that it comprises displaying an indicator associated with the said other column after expansion and on which an action performed by the user using an input user interface causes collapsing the said sub-table in the said single row.

33. Method according to one of claims 22 to 32, characterized in that the indicator associated with the said other column comprises a symbol that can be directed downwards or upwards.

34. Method according to one of claims 22 to 33, characterized in that it comprises displaying in the said other column, one of the values taken by the group of lines in this column.

35. Method according to one of claims 22 to 34, characterized in that it comprises displaying in the said other column, a combination of the values taken by the group of lines in this column.

36. Method according to one of claims 22 to 35, characterized in that it comprises displaying in the said other column, a property such as the cardinality of the set of the values taken by the group of lines in this column or the result of an aggregation function applied on these values.

37. Method according to one of claims 22 to 36, characterized in that it comprises a step of determining a lines selection key for determining a group of lines to which a change of value in a column on the level of a displayed row will apply collectively.

38. Method according to claim 37, characterized in that the said lines selection key is constituted by the values displayed in the column(s) having the indicator(s) from which the sub-table was formed.

39. Method according to claim 37, characterized in that the said lines selection key is constituted by the values displayed in all the columns, including the value before change for the column in which the change is carried out.

40. Method according to claim 37, characterized in that the said lines selection key is constituted by the value before change in the column in question.

41. Method according to claim 37, characterized in that it comprises a step of addition to the lines selection key of a value displayed in a column by the indicator of which no sub-table was formed, by a specific action using an input user interface.

42. Method according to claim 37, characterized in that it comprises a step of removal from the lines selection key of a value displayed in a column by the indicator of which no sub-table was formed, by a specific action using an input user interface.

43. Method according to one of claims 22 to 42, characterized in that, if the resource is built dynamically from a data source, it is able to display in association with the resource an indicator enabling a direct access to the said data source.

44. Method of presentation of data, comprising the following steps:
(a) defining a presentation template for a source from which data can be obtained and manipulated according to the method of one of the claims 22 to 43,
(b) synthesizing at least a part of the said data in the said presentation template according to predetermined rules, and
(c) when with one of the said data an indicator has to be associated according to the said method, to display an equivalent indicator in the said synthesized presentation.
